(19) United States
(12) Patent Application Publication
(10) Pub. No.: US 2021/0009228 A1
(43) Pub. Date: Jan. 14, 2021

(54) SQUAT BICYCLE

(71) Applicant: Edward Wonik YI, Seoul (KR)

(72) Inventor: Edward Wonik YI, Seoul (KR)

(21) Appl. No.: 16/498,185

(22) PCT Filed: Apr. 3, 2018
(86) PCT No.: PCT/KR2018/004359

§ 371 Date: Sep. 26, 2019

(30) Foreign Application Priority Data
Apr. 21, 2017 (KR) 10-2017-0051619

(51) Int. Cl. B62K 17/00; B62K 3/02; B62M 3/16; A63B 22/00

(52) U.S. Cl. CPC B62K 17/00; B62K 3/02; A63B 2022/0635; A63B 22/0087; B62M 3/16

(57) ABSTRACT

A squat bicycle provides a squat bicycle in which a power transmission means and a frame are driven in a linked manner. The frame is configured to include a top tube, a down tube, a seat stay, and a chain stay. The front end of the top tube is hinge-coupled to the down tube, and the rear end is hinge-coupled to the seat stay. The seat stay is divided into a first member in which the front end is hinge-coupled to the top tube and a second member in which the rear end is hinge-coupled to the rear end of the chain stay, and a rear end of the first member is hinge-coupled to a front end of the second member.

### BACKGROUND

The present invention relates to a squat bicycle which can be driven while performing a squat exercise which corresponds to a whole body exercise, and has a function of also being transformable into a general bicycle by means of a simple operation.

A bicycle is mainly composed of three parts, namely, a frame (body), a wheel and a power transmission device.

The frame (body) is configured to include a top tube, a down tube, a seat tube, a seat stay, a chain stay and a head tube.

The wheel is configured such that both front and rear wheels include a rim, a tire, a spoke and a hub.

The power transmission device is configured to include a pedal, a crank, a chain, a chain ring, a sprocket, a transmission and a bottom bracket.

In addition, the bicycle is provided with a handle, a saddle, a brake, a suspension, etc.

Various bicycles, such as a general bicycle, a mountain bicycle, a race bicycle or a leisure bicycle, are being developed. The basic structure of these bicycles does not deviate significantly from the above description. New technology related to the bicycles is mainly focused on problems such as application of new materials, weight reduction and increase in speed.

The conventional bicycle has a uniform structure that performs a single function. However, a bicycle of a new structure has been proposed, which can be driven while taking a squat exercise corresponding to a whole body exercise in addition to performing a general bicycle function. The related art is as follows.

(1) Korean Laid-Open Patent Publication Nos. 10-2017-0019209 and 10-2017-0011594

Korean Laid-Open Patent Publication Nos. 10-2017-0019209 and 10-2017-0011594 are a type of technology that is configured such that a rider's load acting on a saddle is transformed into a driving force acting on a rear wheel.

(2) Korean Patent No. 10-0963449

Korean Patent No. 10-0963449 is provided with a second driving unit to transmit a driving force to a rear wheel by the swinging action of a handle.

Furthermore, a front handle includes a telescopic part to perform both a pedal exercise and a press exercise or to perform both a squat exercise and a press exercise.

### CITED REFERENCES

(Patent Document 1) 1. Korean Laid-Open Patent Publication No. 10-2017-0019209 “Squat bicycle that can be driven by squat exercise”, 2017 Feb. 21.

(Patent Document 2) 2. Korean Laid-Open Patent Publication No. 10-2017-0011594 “Bicycle for squat exercise”, 2017 Feb. 2.

(Patent Document 3) 3. Korean Patent No. 10-0963449 “Bicycle for whole body exercise”, 2010 Jun. 17.

### SUMMARY OF THE INVENTION

The present invention is intended to provide a bicycle that can be driven by operating a rear wheel through a squat exercise using a pedal.

Furthermore, the present invention is intended to provide a squat bicycle that has the function of being transformable into a general bicycle by a simple operation.

The underlying principle for the above-mentioned problem is as follows.

(1) The appearance and structure of a conventional bicycle are maintained to the maximum.

(2) The function and chain system of the conventional bicycle are maintained.

(3) A person that can ride the conventional bicycle should be able to ride immediately.

(4) The function of a whole body exercise is added to that of the conventional bicycle.

(5) One bicycle is freely transformed between a whole-body-exercise mode and a normal mode, and makes it convenient to transform the mode.

According to the above principle, the present invention provides a squat bicycle configured such that power transmission means and a frame are driven in a linked manner, wherein the frame is configured to include a top tube, a down tube, a seat stay, and a chain stay, a front end of the top tube is hinge-coupled to the down tube, and a rear end thereof is hinge-coupled to the seat stay, the seat stay is divided into a first member in which the front end is hinge-coupled to the top tube and a second member in which the rear end is hinge-coupled to the rear end of the chain stay, and a rear end of the first member is hinge-coupled to a front end of the second member, a crank of the power transmission means is divided into a pedal arm and a link arm which share a rotation axis, the squat bicycle is configured to further comprise a lift tube, wherein a bottom end of the lift tube is hinge-coupled to the link arm, and a top end thereof is hinge-coupled to the rear end of the top tube and the front end of the first member of the seat stay, whereby the link arm rotates axially according to axial rotation of the pedal arm to move the lift tube up and down.

Such a squat bicycle is configured such that a part of a coupling structure of the frame is changed into a hinge-coupling structure to allow the bicycle to be driven by a squat exercise while maintaining the frame and a chain system of a conventional bicycle, and the frame and a driving device are driven in a linked manner.

Further, the present invention provides a squat bicycle configured such that it further includes a sub pedal arm provided on the crank and sharing the rotation axis with the pedal arm and the link arm, and the pedal is released from the pedal arm and then is coupled to the sub pedal arm, the bottom end of the lift tube is released from a hinge-coupled state with the link arm, and the lift tube is coupled to the chain stay, so that a driving force according to the axial rotation of the sub pedal arm is converted via the chain into only a force for rotating the rear wheel, with the lift tube, the top tube and the seat stay being fixed.

Such a squat bicycle is configured to be converted between a squat-exercise-driving mode and a general driving mode depending on whether the lift tube is coupled to the link arm or is coupled to the chain stay.

The squat bicycle of the present invention has the following effects.

1. It can be driven by a rider's squat exercise while maximally maintaining the appearance, structure and power transmission means of the conventional bicycle.

2. A person can immediately ride the squat bicycle and enjoy the squat exercise (whole body exercise), as long as he or she can ride the conventional bicycle.

3. One bicycle is freely transformed between a whole-body-exercise mode and a normal mode, and makes it convenient to transform the mode.

### BRIEF DESCRIPTION OF THE DRAWINGS

FIG. 1 is a perspective view illustrating an embodiment of the present invention.

FIG. 2 illustrates a state where the present invention moves a top tube of a frame and a seat stay upwards in a whole-body-exercise mode.

FIG. 3 illustrates a state where the embodiment of FIG. 1 is transformed into a general mode.

### DETAILED DESCRIPTION OF THE INVENTION

Hereinafter, the present invention will be described in detail with reference to the accompanying drawings.

The present invention provides a squat bicycle configured such that a power transmission means and a frame are driven in a linked manner. The frame is configured to include a top tube 10, a down tube 20, a seat stay 30, and a chain stay 40. A front end of the top tube 10 is hinge-coupled to the down tube 20, and a rear end thereof is hinge-coupled to the seat stay 30. The seat stay 30 is divided into a first member 31 in which the front end is hinge-coupled to the top tube 10 and a second member 32 in which the rear end is hinge-coupled to the rear end of the chain stay 40, and a rear end of the first member 31 is hinge-coupled to a front end of the second member 32. A crank 50 of the power transmission means is divided into a pedal arm 51 and a link arm 52 which share a rotation axis. The squat bicycle is configured to further include a lift tube 60, wherein a bottom end of the lift tube is hinge-coupled to the link arm 52, and a top end thereof is hinge-coupled to the rear end of the top tube 10 and the front end of the first member 31 of the seat stay 30, so that the link arm 52 rotates axially according to the axial rotation of the pedal arm 51 to move the lift tube 60 up and down.

The frame of the squat bicycle according to the invention is configured to include the top tube 10, the down tube 20, the seat stay 30, and the chain stay 40. Similarly to the general bicycle, the squat bicycle according to the invention is configured such that a wheel (front and rear wheels), a saddle, a handle, and a power transmission device (pedal, crank, chain, sprocket, etc.) are mounted on the frame. It should be understood that a configuration which is not particularly limited to claims of the present invention may adopt components of the general bicycle.

The frame of the general bicycle is configured such that the top tube, the down tube, the seat tube, the seat stay and the chain stay are fixedly coupled to form an integrated structure. On the other hand, the basic frame of the present invention is configured to include the top tube, the down tube, the seat stay and the chain stay except for the seat tube.

According to the present invention, the down tube 20 and the chain stay 40 are fixedly coupled to form an integrated structure and thereby form a lower structure of the frame. However, the top tube 10 and the seat stay 20 are hinge-coupled to be movable within a predetermined range.

The front end of the top tube 10 is hinge-coupled to the down tube 20, and the rear end thereof is hinge-coupled to the seat stay 30.

The seat stay 30 is divided into the first and second members 31 and 32. The front end of the first member 31 is hinge-coupled to the top tube 10, and the rear end of the second member 32 is hinge-coupled to the rear end of the chain stay 40. Furthermore, the rear end of the first member 31 and the front end of the second member 32 are hinge-coupled to each other.

The basic frame of the present invention is provided with the lift tube 60 in place of the seat tube. The lift tube 60 is a linking member that links the power transmission means with the movement of the frame while supporting the sagging of the top tube 10 and the seat stay 30.

The characteristic component in the power transmission means of the squat bicycle according to the present invention is the crank 50.

The crank 50 is divided into the pedal arm 51 and the link arm 52 which share the rotation axis. The bottom end of the lift tube 60 is hinge-coupled to the link arm 52, and the top end thereof is hinge-coupled to the rear end of the top tube 10 and the front end of the first member 31 of the seat stay 30.

Except for the above-described characteristics, the chain, the chain ring, the sprocket, the transmission and the bottom bracket may be configured in the same manner as the power transmission means of the general bicycle.

According to the above-described configuration, when the pedal arm 51 rotates axially, the link arm 52 also rotates axially. Thereby, the driving force generated by the axial rotation of the pedal arm 51 is transmitted as a force for rotating the rear wheel via the power transmission means such as the chain or the sprocket. Simultaneously, the lift tube 60 moves up and down while the link arm 52 rotates axially.

If the lift tube 60 moves up, the hinge-coupling point of the rear end of the top tube 10 moves up along the trajectory of an arc having the hinge-coupling point of the front end as a center, and the first and second members 31 and 32 of the seat stay 30 are moved away from each other.

Furthermore, the seat post 11 having on the top end the saddle 12 is coupled to the top tube 10, so that a person sitting on the saddle 12 drives the bicycle while repeating a motion (i.e. squat motion) where he or she stands up and sits down by pressing the pedal P coupled to the pedal arm 51 with his or her leg.

To be more specific, the pedal arm P may be configured such that both sides thereof rotate axially forwards in a semicircular trajectory. Thus, a rider's leg force pressing the pedal arm P from an upper position to a lower position acts as force for moving the lift tube 60 upwards while being transmitted via the power transmission means to the operating force, and a rider's body load transmitted through the saddle 12 acts as force for axially rotating the pedal arm P upwards again while moving the lift tube 60 downwards.

The squat bicycle of the present invention is driven as a rider sis on the saddle 12 and repeats standing and sitting motions with both feet on the pedals P. Such a driving state may be similar in appearance to horse-riding.

Meanwhile, a fixed frame 70 is coupled between the down tube 20 and the chain stay 40 to improve the entire stability of the frame.

The fixed frame is configured to include a transverse member 71 coupled at a front end to the down tube 20, a longitudinal member 72 coupled at a bottom end to the front end of the chain stay 40 and coupled at a top end to the rear end of the transverse member 71, and an inclination member 73 coupled at a front end to the longitudinal member 72 and coupled at a rear end to the rear end of the chain stay 40. However, the fixed frame 70 may have various structures in addition to the above-described configuration.

Furthermore, a section of the fixed frame 70 has a buffer spring 74. The buffer spring may offset load and vibration applied to the frame by the vertical movement of the lift tube 60 and the movement of the top tube 10 and the seat tube 30. An embodiment having the buffer spring 74 on the section of the transverse member 71 is illustrated.

Furthermore, the frame according to the present invention may further include a support member 80 that is coupled at one end thereof to the down tube 20 and is coupled at the other end to a damper 81 for supporting the top tube 10 from below.

The top end of the damper 81 may be made of an elastic material, thus absorbing shocks generated by the vertical movement of the top tube 10.

A handle 91 of the squat bicycle according to the present invention may be directly and indirectly coupled to the head tube 90 coupled to the down tube 20. An arch-shaped grip 92 is coupled to the handle 91. It may be appropriate for a rider riding the squat bicycle to hold the arch-shaped grip 92 by his or her hand when repeating standing and sitting motions by pressing the pedal P.

According to the present invention, the bottom end of the lift tube 60 is released from a hinge-coupled state with the link arm 52, and the lift tube 60 is coupled to the chain stay 40, so that a driving force according to the axial rotation of the crank 50 is converted into only an operating force via the power transmission means, with the lift tube 60, the top tube 10 and the seat stay 30 being fixed.

That is, the squat bicycle of the present invention is transformed into the general bicycle by releasing the lift tube 60 from the link arm 52 and then coupling it to the chain stay 40.

Hereinafter, a state where the lift tube 60 is coupled to the link arm 52 so that the rider may take a squat exercise is referred to as the “whole-body-exercise mode”, and a state where the lift tube 60 is released from the link arm 52 and then is coupled to the chain stay 40 is referred to as the “general mode”.

In the general mode, the frame is fixed not to be moved, and the driving of the power transmission means does not affect the frame.

In order to transform between the whole-body-exercise mode and the general mode, the lift tube 60 and the chain stay 40 may be coupled to each other through first and second coupling holes h1 and h2 by forming the first coupling hole h1 in the lift tube 60 and forming the second coupling hole h2 in the chain stay 40.

Furthermore, a sub pedal arm 53 which shares the rotation axis with the pedal arm 51 and is formed in an opposite direction to the pedal arm 51 is coupled to the crank 50, and the pedal P is released from the pedal arm 51 and then is coupled to the sub pedal arm 53. Such a configuration allows the position of the pedal P to be changed in response to transformation between the whole-body-exercise mode and the general mode.

The sub pedal arm 53 may be provided on only either of left and right cranks 50. When the bicycle of the invention is transformed from the whole-body-exercise mode to the general mode by coupling the lift tube 60 to the chain stay 40, the pedal is released from the pedal arm 51 and then is coupled to the sub pedal arm 53, so that left and right pedals may be positioned in opposite directions like the cranks of the general bicycle.

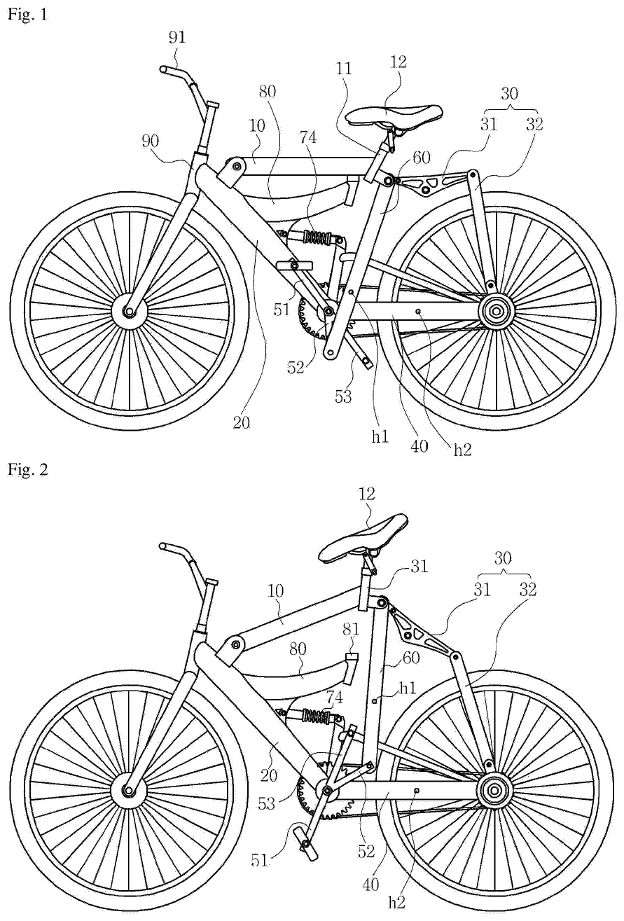

FIG. 1 is a perspective view illustrating an embodiment of the present invention.

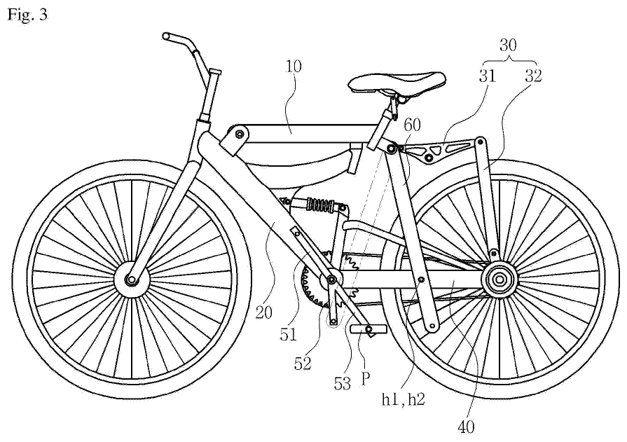

The embodiment of FIG. 1 may transform between the whole-body-exercise mode and the general mode. If a rider presses on both the pedals in the whole-body-exercise mode, as illustrated in FIG. 2, the top tube 10 and the seat stay 30 of the frame move upwards and simultaneously the saddle 12 also moves upwards. That is, since the saddle 12 moves upwards while the pedal moves downwards, the rider can drive the bicycle while repeating the standing and sitting movement, but the saddle 12 is kept near to the rider's buttocks. FIG. 3 illustrates a state where the embodiment of FIG. 1 is transformed into the general mode.

While the invention has been shown and described with reference to exemplary embodiments thereof, it will be understood by those skilled in the art that various changes in form and details may be made therein without departing from the spirit and scope of the invention as defined by the appended claims.

### DESCRIPTION OF REFERENCE NUMERALS OF IMPORTANT PARTS

10: top tube 11: seat post 12: saddle
20: down tube
30: seat stay 31: first member 32: second member
40: chain stay
50: crank 51: pedal arm 52: link arm
53: sub pedal arm
60: lift tube
70: fixed frame 71: transverse member 72: longitudinal member
73: inclination member 74: buffer spring
80: support member 81: damper
90: head tube 91: handle 92: arch-shaped grip
h1: first coupling hole h2: second coupling hole P: pedal

1. A squat bicycle configured such that power transmission means and a frame are driven in a linked manner,
wherein the frame is configured to include a top tube, a down tube, a seat stay, and a chain stay,
a front end of the top tube is hinge-coupled to the down tube, and a rear end thereof is hinge-coupled to the seat stay,
the seat stay is divided into a first member in which the front end is hinge-coupled to the top tube and a second member in which the rear end is hinge-coupled to the rear end of the chain stay, and a rear end of the first member is hinge-coupled to a front end of the second member,
a crank of the power transmission means is divided into a pedal arm and a link arm which share a rotation axis,
the squat bicycle is configured to further comprise a lift tube, wherein a bottom end of the lift tube is hinge-coupled to the link arm, and a top end thereof is hinge-coupled to the rear end of the top tube and the front end of the first member of the seat stay,
whereby the link arm rotates axially according to axial rotation of the pedal arm to move the lift tube up and down,
the bottom end of the lift tube is released from a hinge-coupled state with the link arm, and the lift tube is coupled to the chain stay, so that a driving force according to axial rotation of the crank is converted into only an operating force via the power transmission means, with the lift tube, the top tube and the seat stay being fixed.

2. The squat bicycle of claim 1, wherein a seat post having a saddle on a top end thereof is coupled to the top tube.

3. The squat bicycle of claim 2, wherein the pedal arm is configured such that both sides thereof rotate axially forwards in a semicircular trajectory,
a rider's leg force pressing the pedal arm from an upper position to a lower position acts as force for moving the lift tube upwards while being transmitted via the power transmission means to the operating force, and
a rider's body load transmitted through the saddle acts as force for axially rotating the pedal arm upwards again while moving the lift tube downwards.

4. The squat bicycle of claim 1, further comprising:
a fixed frame coupled between the down tube and the chain stay.

5. The squat bicycle of claim 4, wherein a section of the fixed frame comprises a buffer spring.

6. The squat bicycle of claim 1, further comprising:
a support member coupled at one end thereof to the down tube and coupled at the other end to a damper for supporting the top tube from below.

7. The squat bicycle of claim 1, wherein a head tube is coupled to the down tube, a handle is directly or indirectly coupled to the head tube, and an arch-shaped grip is coupled to the handle.

8. The squat bicycle of claim 1, wherein a first coupling hole is formed in the lift tube, a second coupling hole is formed in the chain stay, and the lift tube and the chain stay are coupled through the first and second coupling holes.

9. The squat bicycle of claim 1, further comprising:
a sub pedal arm provided on the crank, sharing the rotation axis with the pedal arm, and formed in an opposite direction to the pedal arm, and
the pedal is released from the pedal arm and then is coupled to the sub pedal arm.
